(19) United States
(12) Patent Application Publication
(10) Pub. No.: US 2015/0043197 A1
(43) Pub. Date: Feb. 12, 2015

(54) PLANAR LIGHTING DEVICE USING LIGHT EMITTING DIODES

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/020,888

(22) Filed: Sep. 8, 2013

(30) Foreign Application Priority Data
Aug. 6, 2013 (TW) 102128015

(51) Int. Cl. F21K 99/00

(52) U.S. Cl. CPC F21K 9/50
USPC 362/97.3

(57) ABSTRACT

A planar LED lighting device includes a reflective sheet comprising a reflective surface and a plurality of LEDs arranged on the reflective surface. Each LED comprises a light emitting surface. A plurality of first optical elements cover the LEDs. A plurality second optical elements face the first optical elements. Each second optical element has a total reflective surface facing a corresponding first optical element. A light diffusing sheet is located above the second optical elements. Light beams emitted from the LEDs are collimated by the first optical elements, then divergently reflected by the total reflective surfaces of the second optical elements to reach the reflective sheet, thereafter scattered and reflected by the reflective sheet and then travel to the light diffusing sheet to be diffused thereby. Finally, the diffused light beams leave the light diffusing sheet to an outside.

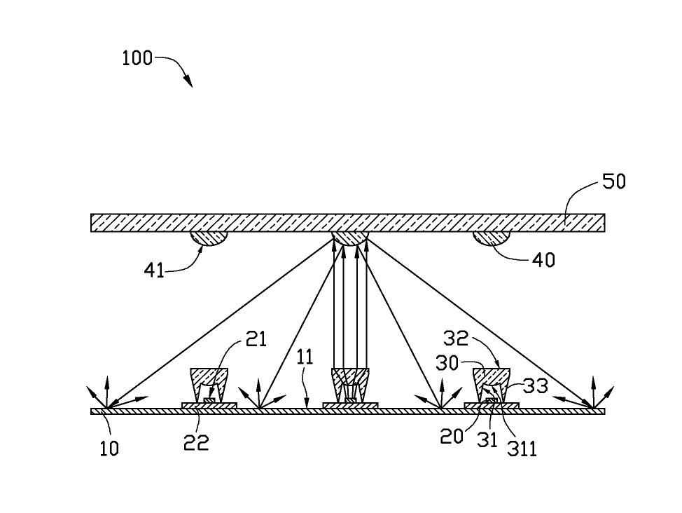

### BACKGROUND 1. Technical Field

The disclosure relates to a planar lighting device using light emitting diodes (LEDs), and particularly to an LED backlight module having even distribution of light emission.

2. Discussion of Related Art

Light emitting diodes' (LEDs) many advantages, such as high luminosity, low operational voltage, low power consumption, compatibility with integrated circuits, faster switching, long term reliability, and environmental friendliness have promoted their wide use as a lighting source.

However, the conventional LED cannot have a wide illumination area even use with a diverging lens. The light having a large incidence angle on the light emerging face of the diverging lens, may be totally reflected backwardly into the diverging lens. Thus, the radiation angle of the light emitted out of the diverging lens is limited, generally less than 120 degrees. In other words, the light intensity dramatically decreases when the radiation angle exceeds 120 degrees. When using such LEDs as light source of a backlight module, hot spots will be eminent from the light diffusing sheet at positions corresponding to the LEDs. Such hot spots cause an LCD (liquid crystal display) illuminated by the backlight module to have uneven brightness, resulting in a poor picture quality of the LCD.

Therefore, what is needed is a planar lighting device using LEDs as light source, for example, an LED backlight module which can overcome the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present LED backlight module. Moreover, in the drawing, like reference numerals designate corresponding parts throughout the whole view.

The only drawing is a cross-sectional view of an LED backlight module in accordance with an exemplary embodiment of the present disclosure.

### DETAILED DESCRIPTION OF EMBODIMENTS

Referring to the only drawing, an LED backlight module 100 in accordance with an exemplary embodiment of the present disclosure is shown. The LED backlight module 100 includes a reflective sheet 10, a plurality of LEDs 20, a plurality of first optical elements 30, a plurality second optical elements 40, and a light diffusing sheet 50. The LED backlight module 100 is provided for illuminating an LCD (liquid crystal display).

The reflective sheet 10 includes a reflective surface 11. A plurality of scattering particles can be arranged on the reflective surface 11 to scatter light emitted from the LEDs 20 and reflected by the second optical elements 40 to the reflective sheet 10. In the present embodiment, the reflective sheet 10 is a white reflective sheet, and the reflective surface 11 is a total reflective surface with light scattering function.

The LEDs 20 are arranged on the reflective surface 11 of the reflective sheet 10. Each LED 20 has a light emitting surface 21 away from the reflective sheet 10. In the present embodiment, each LED 20 is arranged on the reflective surface 11 via a base 22. The base 22 can be a print circuit board or a heat dissipating substrate.

The first optical elements 30 are respectively arranged on light paths of the LEDs 20. Each first optical element 30 is arranged on a base 22 and surrounds a corresponding LED 20. Each first optical element 30 is spaced from and dose not contact the corresponding LED 20. Light emitted from the LED 20 is concentrated by the corresponding first optical element 30. In the present embodiment, the first optical elements 30 is a collimating lens, and includes a light input surface 31, a light output surface 32 opposite to the light input surface 31, and a side surface 33 positioned between and connected to the light input surface 31 and the light output surface 32. The light input surface 31 includes a convex surface 311 protruding towards the LED 20. The light output surface 32 is a planar surface, and the side surface 33 is a frusto-conical surface. The side surface 33 is a total reflective face. Light beams emitted from the LED 20 pass through the light input surface 31 and enter the first optical element 30. A part of light beams travels through the first optical element 30 to an outside through the light output surface 32 directly, and the other part of light beams is reflected by the side surface 33 and then travels through the light output surface 32 of the first optical element 30 to the outside. All light beams travelling through the first optical element 30 are collimated by the first optical element 30.

The second optical elements 40 are respectively opposite to and aligned with the first optical elements 30. Each second optical element 40 includes a total reflective surface 41 facing the first optical elements 30. In the present embodiment, the total reflective surface 41 is an aspheric surface.

The light diffusing sheet 50 faces the reflective surface 11 of the reflective sheet 10 and is located above the second optical elements 40 and away from the first optical element 30. The second optical elements 40 are secured to a bottom surface of the light diffusing sheet 50 facing the LEDs 20.

Light beams emitted from the LED 20 travel through the first optical elements 30 and are collimated by the first optical elements 30 to be parallel light beams. The parallel light beams travel to the second optical elements 40. Then, the parallel light beams are reflected by the total reflective surfaces 41 of the second optical elements 40 divergently to the reflective surface 11 of the reflective sheet 10. The divergently reflected light beams are further reflected and scattered by the reflective surface 11 of the reflective sheet 10 and then travel back to the light diffusing sheet 50, wherein the light beams are diffused by the light diffusing sheet 50 and then emitted to an outside of the LED backlight module 100 to illuminate the LCD. By the collimation of the first optical elements 30, the total reflection of the second optical elements 40 and the reflecting and scattering function of the reflective surface 11, the light beams generated by the LEDs 20 can be more uniformly emitted into the light diffusing sheet 50, whereby the LED backlight module 100 can more uniformly illuminate the LCD.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A planar light emitting diode (LED) lighting device, comprising:
a reflective sheet comprising a reflective surface;
a plurality of LEDs arranged on the reflective surface of the reflective sheet, each LED comprising a light emitting surface away from the reflective sheet;
a plurality of first optical elements, each first optical element being arranged on a light path of one of the LEDs;
a plurality second optical elements, each second optical element being opposite to and aligned with one of the first optical elements, each second optical element having a total reflective surface facing a corresponding one of the first optical elements; and
a light diffusing sheet located above the second optical elements and away from the first optical element;
wherein light beams emitted from the LEDs are collimated by the first optical elements to radiate toward the second optical elements, the collimated light beams are divergently reflected by the total reflective surface faces of the second optical elements to radiate toward the reflective sheet, and then scattered and reflected by the reflective surface of the reflective sheet to travel to the light diffusing sheet wherein the light beams are diffused by the light diffusing sheet before emitting to an outside of the planar LED lighting device.

2. The planar LED lighting device of claim 1, wherein the reflective sheet is a white reflective sheet.

3. The planar LED lighting device of claim 1, wherein each of the first optical elements is a collimating lens.

4. The planar LED lighting device of claim 1, wherein each of the first optical elements comprises a light input surface, a light output surface opposite to the light input surface, and a side surface located between and connected to the light input surface and the light output surface, the light input surface comprising a convex surface facing and protruding towards a corresponding LED, the light output surface being a planar surface, and the side surface being a frusto-conical surface.

5. The planar LED lighting device of claim 1, wherein each of the first optical elements covers a corresponding LED.

6. The planar LED lighting device of claim 1, wherein a plurality of scattering particles are arranged on the reflective surface.

7. The planar LED lighting device of claim 1, wherein the reflective surface of the reflective sheet is a total reflective surface.

8. The planar LED lighting device of claim 1, wherein the total reflective surface of each of the second optical elements is an aspheric surface.

9. The planar LED lighting device of claim 1, wherein the second optical elements are arranged on a surface of the light diffusing sheet facing the LEDs.

10. A planar LED lighting device, comprising:
a reflective sheet comprising a reflective surface;
a light diffusing sheet facing the reflective surface of the reflective sheet;
a plurality of LEDs arranged on the reflective surface of the reflective sheet; and
a plurality of first optical elements and second optical elements located between the reflective sheet and the light diffusing sheet, each first optical element and each second optical element being arranged on a light path of one of the LEDs, each second optical element having a total reflective surface;
wherein light beams emitted from the LEDs are sequentially collimated by the first optical elements, divergently reflected by the total reflective surface face of the second optical elements to the reflective sheet, scattered and reflected by the reflective sheet and finally travel through the light diffusing sheet to an outside.

11. The planar LED lighting device of claim 10, wherein each of the first optical elements covers and surrounds a corresponding LED.

12. The planar LED lighting device of claim 10, wherein the second optical elements are arranged on a surface of the light diffusing sheet facing the LEDs.

13. The planar LED lighting device of claim 10, wherein each of the first optical elements is a collimating lens.

14. The planar LED lighting device of claim 10, wherein each of the first optical elements comprises a light input surface, a light output surface opposite to the light input surface, and a side surface located between and connected to the light input surface and the light output surface, the light input surface comprising a convex surface facing and protruding towards the LED, the light output surface being a planar surface, and the side surface being a frusto-conical surface.
